(19) United States
(12) Patent Application Publication
(10) Pub. No.: US 2004/0107195 A1
(43) Pub. Date: Jun. 3, 2004

(54) Information storage and retrieval

(76) Inventor: David William Trepess, Basingstoke (GB)

Correspondence Address: WILLIAM S. FROMMER, Esq., c/o FROMMER LAWRENCE & HAUG LLP, 745 Fifth Avenue, New York, NY, 10151, US

(21) Appl. No.: 10/720,787

(22) Filed: Nov. 24, 2003

(30) Foreign Application Priority Data
Nov. 27, 2002 (GB) 0227657.4

(51) Int. Cl. G06F 7/00

(52) U.S. Cl. 707/3

(57) ABSTRACT

An information retrieval system in which a set of distinct information items map to respective nodes in an array of nodes by mutual similarity of the information items, so that similar information items map to nodes at similar positions in the array of nodes; the system comprising:

a user control for defining a search criterion for selecting information items;

a detector for detecting those positions within the array of nodes corresponding to the selected information items; and

a graphical user interface for displaying display points which are at positions within a display area on a user display;

the graphical user interface also displaying in a sequence in time a plurality of representations of the selected information items.

### BACKGROUND OF THE INVENTION

1. Field of the Invention

### Information Storage and Retrieval

This invention relates to information storage and retrieval.

2. Description of the Prior Art

There are many established systems for locating information (e.g. documents, images, emails, patents, internet content or media content such as audio/video content) by searching under keywords. Examples include internet search “engines” such as those provided by “Google” ™ or “Yahoo” ™ where a search carried out by keyword leads to a list of results which are ranked by the search engine in order of perceived relevance.

However, in a system encompassing a large amount of information, often referred to as a massive content collection, it can be difficult to formulate effective search queries to give a relatively short list of search “hits”. For example, at the time of preparing the present application, a Google search on the keywords “massive document collection” drew 243000 hits. This number of hits would be expected to grow if the search were repeated later, as the amount of content stored across the internet generally increases with time. Reviewing such a list of hits can be prohibitively time-consuming.

In general, some reasons why massive content collections are not well utilised are:

a user doesn't know that relevant content exists

a user knows that relevant content exists but does not know where it can be located

a user knows that content exists but does not know it is relevant

a user knows that relevant content exists and how to find it, but finding the content takes a long time

The paper “Self Organisation of a Massive Document Collection”, Kohonen et al, IEEE Transactions on Neural Networks, Vol 11, No. 3, May 2000, pages 574-585 discloses a technique using so-called “self-organising maps” (SOMs). These make use of so-called unsupervised self-learning neural network algorithms in which “feature vectors” representing properties of each document are mapped onto nodes of a SOM.

In the Kohonen et al paper, a first step is to pre-process the document text, and then a feature vector is derived from each pre-processed document. In one form, this may be a histogram showing the frequencies of occurrence of each of a large dictionary of words. Each data value (i.e. each frequency of occurrence of a respective dictionary word) in the histogram becomes a value in an n-value vector, where n is the total number of candidate words in the dictionary (43222 in the example described in this paper). Weighting may be applied to the n vector values, perhaps to stress the increased relevance or improved differentiation of certain words.

The n-value vectors are then mapped onto smaller dimensional vectors (i.e. vectors having a number of values m (500 in the example in the paper) which is substantially less than n. This is achieved by multiplying the vector by an (n×m) “projection matrix” formed of an array of random numbers. This technique has been shown to generate vectors of smaller dimension where any two reduced-dimension vectors have much the same vector dot product as the two respective input vectors. This vector mapping process is described in the paper “Dimensionality Reduction by Random Mapping: Fast Similarity Computation for Clustering”, Kaski, Proc IJCNN, pages 413-418, 1998.

The reduced dimension vectors are then mapped onto nodes (otherwise called neurons) on the SOM by a process of multiplying each vector by a “model” (another vector). The models are produced by a learning process which automatically orders them by mutual similarity onto the SOM, which is generally represented as a two-dimensional grid of nodes. This is a non-trivial process which took Kohonen et al six weeks on a six-processor computer having 800 MB of memory, for a document database of just under seven million documents. Finally the grid of nodes forming the SOM is displayed, with the user being able to zoom into regions of the map and select a node, which causes the user interface to offer a link to an internet page containing the document linked to that node.

The inventors of the present invention have realised that a user of such a Self Organising Map needs to have an awareness of the information associated with the selected node or nodes for efficient searching so that the user can check the information they have selected and/or to refine their search.

### SUMMARY OF THE INVENTION

This invention provides an information retrieval system in which a set of distinct information items map to respective nodes in an array of nodes by mutual similarity of the information items, so that similar information items map to nodes at similar positions in the array of nodes; the system comprising:

a user control for defining a search criterion for selecting information items;

a detector for detecting those positions within the array of nodes corresponding to the selected information items; and

a graphical user interface for displaying display points which are at positions within a display area on a user display;

the graphical user interface also displaying in a sequence in time a plurality of representations of the selected information items.

The invention builds on the processes described in the Kohonen et al paper by providing a user interface conveniently allowing the user to associate displayed points on the screen with representations of information items represented by the display points to provide the user with a greater awareness of the information associated with the display points.

The representations which are displayed in sequence may be representations of the information items associated with the display points or alternatively may be links to the information items.

Preferably, the graphical user interface is operable to display a two-dimensional display array of said display points. The interface could display a one dimensional array or a three dimensional array. The third dimension of the three dimensional array may be time.

Further respective aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 schematically illustrates an information storage and retrieval system;

FIG. 2 is a schematic flow chart showing the generation of a self-organising map (SOM);

FIGS. 3a and 3b schematically illustrate term frequency histograms;

FIG. 4a schematically illustrates a raw feature vector;

FIG. 4b schematically illustrates a reduced feature vector;

FIG. 5 schematically illustrates an SOM;

FIG. 6 schematically illustrates a dither process;

FIGS. 7 and 8 schematically illustrate display screens providing a user interface to access information represented by the SOM;

FIG. 9 is a schematic flow diagram illustrating a searching process;

FIGS. 10 to 12 illustrate modes in accordance with the present invention for presenting the results of the search process of FIG. 9;

FIG. 13 schematically illustrates a camcorder as an example of a video acquisition and/or processing apparatus; and

FIG. 14 schematically illustrates a personal digital assistant as an example of portable data processing apparatus

### DESCRIPTION OF THE PREFERRED EMBODIMENTS

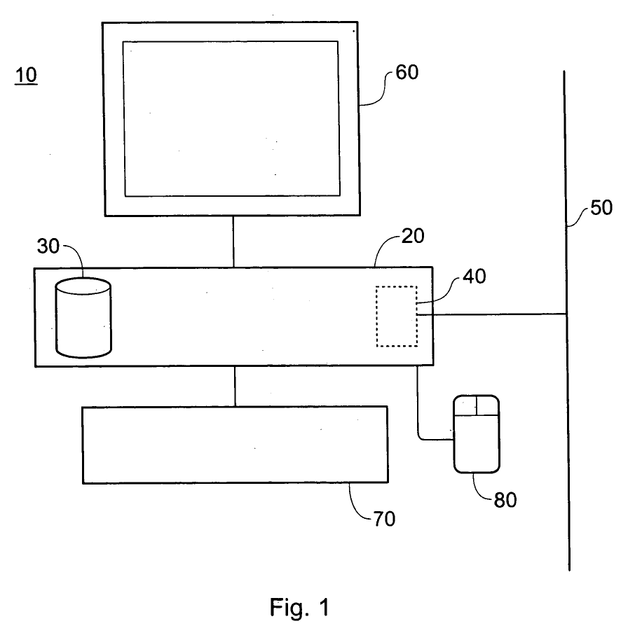

FIG. 1 is a schematic diagram of an information storage and retrieval system based around a general-purpose computer 10 having a processor unit 20 including disk storage 30 for programs and data, a network interface card 40 connected to a network 50 such as an Ethernet network or the Internet, a display device such as a cathode ray tube device 60, a keyboard 70 and a user input device such as a mouse 80. The system operates under program control, the programs being stored on the disk storage 30 and provided, for example, by the network 50, a removable disk (not shown) or a pre-installation on the disk storage 30.

The storage system operates in two general modes of operation. In a first mode, a set of information items (e.g. textual information items) is assembled on the disk storage 30 or on a network disk drive connected via the network 50 and is sorted and indexed ready for a searching operation. The second mode of operation is the actual searching against the indexed and sorted data.

The embodiments are applicable to many types of information items. A non-exhaustive list of appropriate types of information includes patents, video material, emails, presentations, internet content, broadcast content, business reports, audio material, graphics and clipart, photographs and the like, or combinations or mixtures of any of these. In the present description, reference will be made to textual information items. The textual information items may be associated with or linked to, non-textual items. So, for example, audio and/or video material may be associated with “MetaData” which is a textual information item defining that material in textual terms.

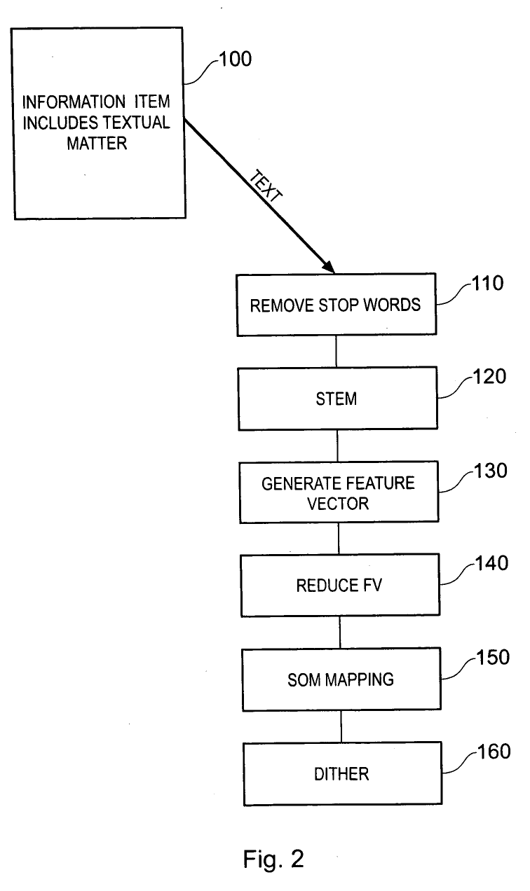

The information items are loaded onto the disk storage 30 in a conventional manner. Preferably, they are stored as part of a database structure which allows for easier retrieval and indexing of the items, but this is not essential. Once the information items have been so stored, the process used to arrange them for searching is shown schematically in FIG. 2.

It will be appreciated that the indexed information items need not be stored on the local disk drive 30. The information items could be stored on a remote drive connected to the system 10 via the network 50. Alternatively, information may be stored in a distributed manner, for example at various sites across the internet. If the information is stored at different internet or network sites, a second level of information storage could be used to store locally a “link” (e.g. a URI—universal resource identifier) to the remote information, perhaps with an associated summary, abstract or MetaData associated with that link. So, the remotely held information would not be accessed unless the user selected the relevant link (e.g. from the results list 260 to be described below), although for the purposes of the technical description which follows, the remotely held information, or the abstract/summary/MetaData, or the link/URI could be considered as the “information item”.

In other words, a formal definition of the “information item” is an item from which a feature vector is derived and processed (see below) to provide a mapping to the SOM. The data shown in the results list 260 (see below) may be the actual information item which a user seeks (if it is held locally and is short enough for convenient display) or may be data representing and/or pointing to the information item, such as one or more of MetaData, a URI, an abstract, a set of key words, a representative key stamp image or the like. This is inherent in the operation “list” which often, though not always, involves listing data representing a set of items.

In a further example, the information items could be stored across a networked work group, such as a research team or a legal firm. A hybrid approach might involve some information items stored locally and/or some information items stored across a local area network and/or some information items stored across a wide area network. In this case, the system could be useful in locating similar work by others, for example in a large multi-national research and development organisation, similar research work would tend to be mapped to similar output nodes in the SOM (see below). Or, if a new television programme is being planned, the present technique could be used to check for its originality by detecting previous programmes having similar content.

It will also be appreciated that the system 10 of FIG. 1 is but one example of possible systems which could use the indexed information items. Although it is envisaged that the initial (indexing) phase would be carried out by a reasonably powerful computer, most likely by a non-portable computer, the later phase of accessing the information could be carried out at a portable machine such as a “personal digital assistant” (a term for a data processing device with display and user input devices, which generally fits in one hand), a portable computer such as a laptop computer, or even devices such as a mobile telephone, a video editing apparatus or a video camera. In general, practically any device having a display could be used for the information-accessing phase of operation.

The processes are not limited to particular numbers of information items.

The process of generating a self-organising map (SOM) representation of the information items will now be described with reference to FIGS. 2 to 6. FIG. 2 is a schematic flow chart illustrating a so-called “feature extraction” process followed by an SOM mapping process.

Feature extraction is the process of transforming raw data into an abstract representation. These abstract representations can then be used for processes such as pattern classification, clustering and recognition. In this process, a so-called “feature vector” is generated, which is an abstract representation of the frequency of terms used within a document.

The process of forming the visualisation through creating feature vectors includes:

Create “document database dictionary” of terms

Create “term frequency histograms” for each individual document based on the “document database dictionary”

Reduce the dimension of the “term frequency histogram” using random mapping Create a 2-dimensional visualisation of the information space.

Considering these steps in more detail, each document (information item) 100 is opened in turn. At a step 110, all “stop words” are removed from the document. Stop-words are extremely common words on a pre-prepared list, such as “a”, “the”, “however”, “about”, “and”, and “the”. Because these words are extremely common they are likely, on average, to appear with similar frequency in all documents of a sufficient length. For this reason they serve little purpose in trying to characterise the content of a particular document and should therefore be removed.

After removing stop-words, the remaining words are stemmed at a step 120, which involves finding the common stem of a word's variants. For example the words “thrower”, “throws”, and “throwing” have the common stem of “throw”.

A “dictionary” of stemmed words appearing in the documents (excluding the “stop” words) is maintained. As a word is newly encountered, it is added to the dictionary, and running count of the number of times the word has appeared in the whole document collection (set of information items) is also recorded. The result is a list of terms used in all the documents in the set, along with the frequency with which those terms occur. Words that occur with too high or too low a frequency are discounted, which is to say that they are removed from the dictionary and do not take part in the analysis which follows. Words with too low a frequency may be misspellings, made up, or not relevant to the domain represented by the document set. Words that occur with too high a frequency are less appropriate for distinguishing documents within the set. For example, the term “News” is used in about one third of all documents in a test set of broadcast-related documents, whereas the word “football” is used in only about 2% of documents in the test set. Therefore “football” can be assumed to be a better term for characterising the content of a document than “News”. Conversely, the word “fottball” (a misspelling of “football”) appears only once in the entire set of documents, and so is discarded for having too low an occurrence. Such words may be defined as those having a frequency of occurrence which is lower than two standard deviations less than the mean frequency of occurrence, or which is higher than two standard deviations above the mean frequency of occurrence. A feature vector is then generated at a step 130.

To do this, a term frequency histogram is generated for each document in the set.

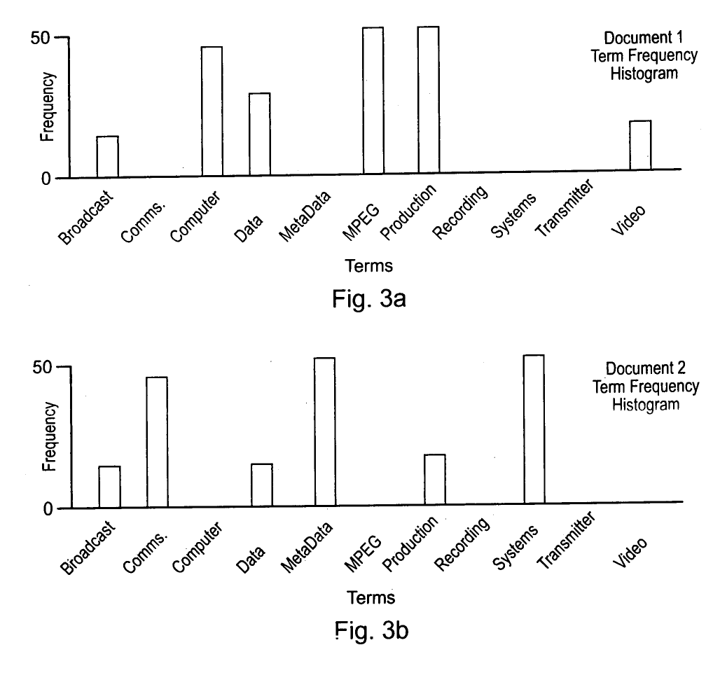

A term frequency histogram is constructed by counting the number of times words present in the dictionary (pertaining to that document set) occur within an individual document. The majority of the terms in the dictionary will not be present in a single document, and so these terms will have a frequency of zero. Schematic examples of term frequency histograms for two different documents are shown in FIGS. 3a and 3b.

It can be seen from this example how the histograms characterise the content of the documents. By inspecting the examples it is seen that document 1 has more occurrences of the terms “MPEG” and “Video” than document 2, which itself has more occurrences of the term “MetaData”. Many of the entries in the histogram are zero as the corresponding words are not present in the document.

In a real example, the actual term frequency histograms have a very much larger number of terms in them than the example. Typically a histogram may plot the frequency of over 50000 different terms, giving the histogram a dimension of over 50000. The dimension of this histogram needs to be reduced considerably if it is to be of use in building an SOM information space.

Each entry in the term frequency histogram is used as a corresponding value in a feature vector representing that document. The result of this process is a (50000×1) vector containing the frequency of all terms specified by the dictionary for each document in the document collection. The vector may be referred to as “sparse” since most of the values will typically be zero, with most of the others typically being a very low number such as 1.

The size of the feature vector, and so the dimension of the term frequency histogram, is reduced at a step 140. Two methods are proposed for the process of reducing the dimension of the histogram.

i) Random Mapping—a technique by which the histogram is multiplied by a matrix of random numbers. This is a computationally cheap process.

ii) Latent Semantic Indexing—a technique whereby the dimension of the histogram is reduced by looking for groups of terms that have a high probability of occurring simultaneously in documents. These groups of words can then be reduced to a single parameter. This is a computationally expensive process.

The method selected for reducing the dimension of the term frequency histogram in the present embodiment is “random mapping”, as explained in detail in the Kaski paper referred to above. Random mapping succeeds in reducing the dimension of the histogram by multiplying it by a matrix of random numbers.

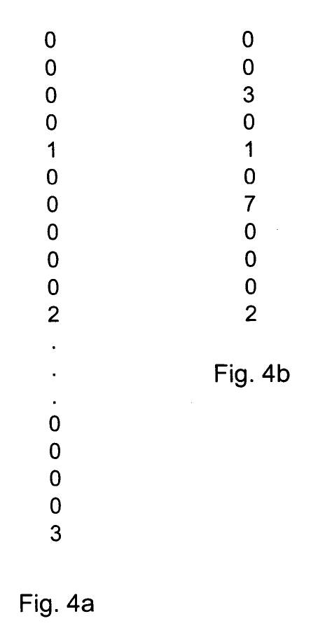

As mentioned above, the “raw” feature vector (shown schematically in FIG. 4a) is typically a sparse vector with a size in the region of 50000 values. This can be reduced to size of about 200 (see schematic FIG. 4b) and still preserve the relative characteristics of the feature vector, that is to say, its relationship such as relative angle (vector dot product) with other similarly processed feature vectors. This works because although the number of orthogonal vectors of a particular dimension is limited, the number of nearly orthogonal vectors is very much larger.

In fact as the dimension of the vector increases any given set of randomly generated vectors are nearly orthogonal to each other. This property means that the relative direction of vectors multiplied by this a matrix of random numbers will be preserved. This can be demonstrated by showing the similarity of vectors before and after random mapping by looking at their dot product.

It can be shown experimentally that by reducing a sparse vector from 50000 values to 200 values preserves their relative similarities. However, this mapping is not perfect, but suffices for the purposes of characterising the content of a document in a compact way.

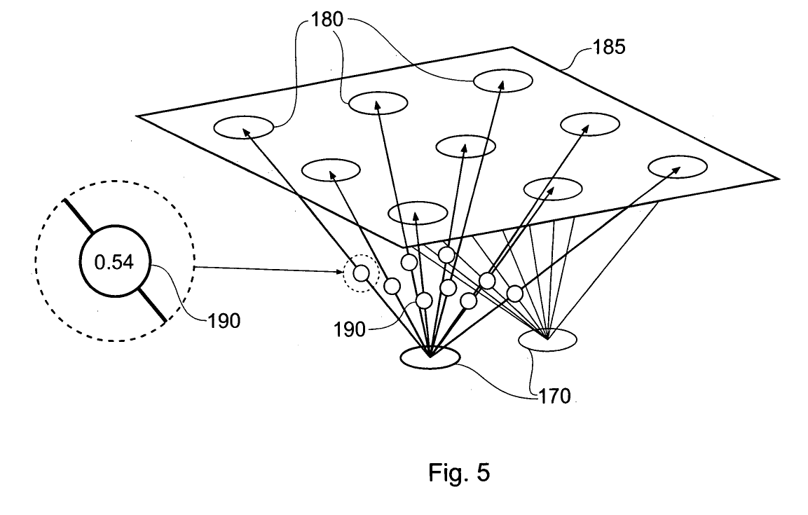

Once feature vectors have been generated for the document collection, thus defining the collection's information space, they are projected into a two-dimensional SOM at a step 150 to create a semantic map. The following section explains the process of mapping to 2-D by clustering the feature vectors using a Kohonen self-organising map. Reference is also made to FIG. 5.

A Kohonen Self-Organising map is used to cluster and organise the feature vectors that have been generated for each of the documents.

A self-organising map consists of input nodes 170 and output nodes 180 in a two-dimensional array or grid of nodes illustrated as a two-dimensional plane 185. There are as many input nodes as there are values in the feature vectors being used to train the map. Each of the output nodes on the map is connected to the input nodes by weighted connections 190 (one weight per connection).

Initially each of these weights is set to a random value, and then, through an iterative process, the weights are “trained”. The map is trained by presenting each feature vector to the input nodes of the map. The “closest” output node is calculated by computing the Euclidean distance between the input vector and weights of each of the output nodes.

The closest node is designated the “winner” and the weights of this node are trained by slightly changing the values of the weights so that they move “closer” to the input vector. In addition to the winning node, the nodes in the neighbourhood of the winning node are also trained, and moved slightly closer to the input vector.

It is this process of training not just the weights of a single node, but the weights of a region of nodes on the map, that allow the map, once trained, to preserve much of the topology of the input space in the 2-D map of nodes.

Once the map is trained, each of the documents can be presented to the map to see which of the output nodes is closest to the input feature vector for that document. It is unlikely that the weights will be identical to the feature vector, and the Euclidean distance between a feature vector and its nearest node on the map is known as its “quantisation error”.

By presenting the feature vector for each document to the map to see where it lies yields an x, y map position for each document. These x, y positions when put in a look up table along with a document ID can be used to visualise the relationship between documents.

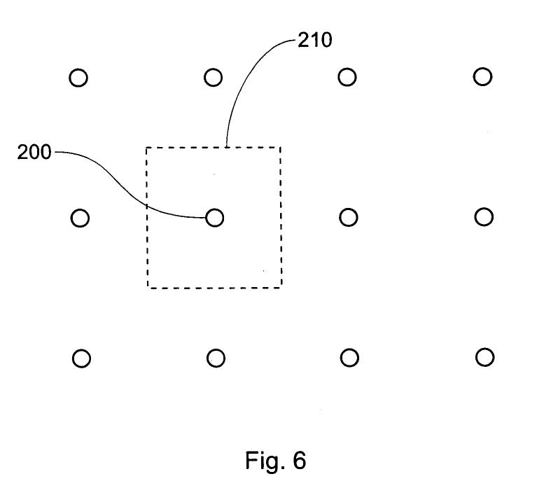

Finally, a dither component is added at a step 160, which will be described with reference to FIG. 6 below.

A potential problem with the process described above is that two identical, or substantially identical, information items may be mapped to the same node in the array of nodes of the SOM. This does not cause a difficulty in the handling of the data, but does not help with the visualisation of the data on a display screen (to be described below). In particular, when the data is visualised on a display screen, it has been recognised that it would be useful for multiple very similar items to be distinguishable over a single item at a particular node. Therefore, a “dither” component is added to the node position to which each information item is mapped. The dither component is a random addition of ±½ of the node separation. So, referring to FIG. 6, an information item for which the mapping process selects an output node 200 has a dither component added so that it in fact may be mapped to any map position around a node 200 within the area 210 bounded by dotted lines on FIG. 6.

So, the information items can be considered to map to positions on the plane of FIG. 6 at node positions other than the “output nodes” of the SOM process.

At any time, a new information item can be added to the SOM by following the steps outlined above (i.e. steps 110 to 140) and then applying the resulting reduced feature vector to the “pre-trained” SOM models, that is to say, the set of SOM models which resulted from the self-organising preparation of the map. So, for the newly added information item, the map is not generally “retrained”; instead steps 150 and 160 are used with all of the SOM models not being amended. To retrain the SOM every time a new information item is to be added is computationally expensive and is also somewhat unfriendly to the user, who might grow used to the relative positions of commonly accessed information items in the map.

However, there may well come a point at which a retraining process is appropriate. For example, if new terms (perhaps new items of news, or a new technical field) have entered into the dictionary since the SOM was first generated, they may not map particularly well to the existing set of output nodes. This can be detected as an increase in a so-called “quantisation error” detected during the mapping of newly received information item to the existing SOM. In the present embodiments, the quantisation error is compared to a threshold error amount. If it is greater than the threshold amount then either (a) the SOM is automatically retrained, using all of its original information items and any items added since its creation; or (b) the user is prompted to initiate a retraining process at a convenient time. The retraining process uses the feature vectors of all of the relevant information items and reapplies the steps 150 and 160 in full.

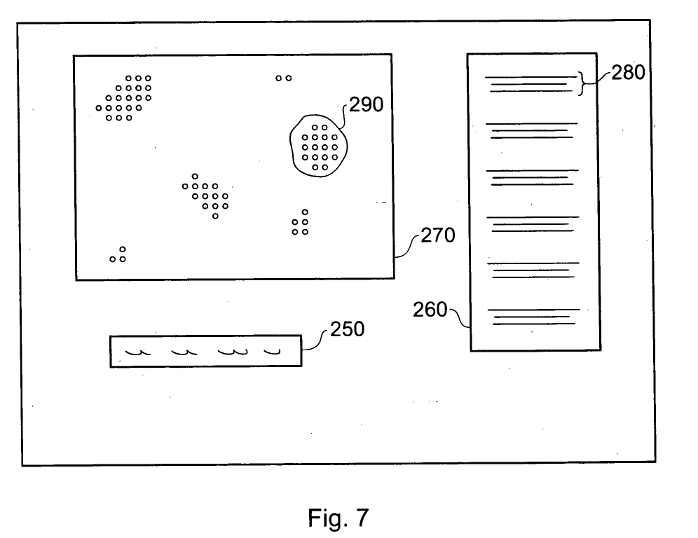

FIG. 7 schematically illustrates a display on the display screen 60 in which data sorted into an SOM is graphically illustrated for use in a searching operation. The display shows a search enquiry 250, a results list 260 and an SOM display area 270.

In operation, the user types a key word search enquiry into the enquiry area 250. The user then initiates the search, for example by pressing enter on the keyboard 70 or by using the mouse 80 to select a screen “button” to start the search. The key words in the search enquiry area 250 are then compared with the information items in the database using a standard keyword search technique. This generates a list of results, each of which is shown as a respective entry 280 in the list area 260. The display area 270 displays only points corresponding to each of the result items.

Because the sorting process used to generate the SOM representation tends to group mutually similar information items together in the SOM, the results for the search enquiry generally tend to fall in clusters such as a cluster 290. Here, it is noted that each point on the area 270 corresponds to the respective entry in the SOM associated with one of the results in the result list 260; and the positions at which the points are displayed within the area 270 correspond to the array positions of those nodes within the node array.

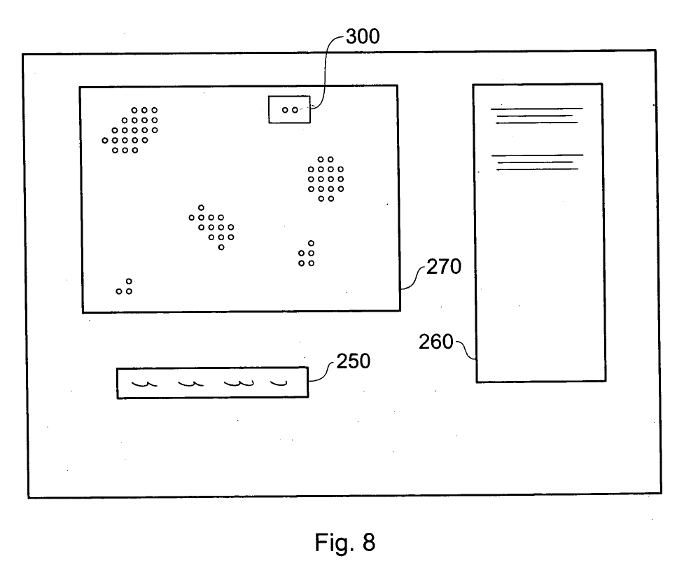

FIG. 8 schematically illustrates a technique for reducing the number of “hits” (results in the result list). The user makes use of the mouse 80 to draw a boundary, which in this example is a rectangular box 300, around a set of display points corresponding to nodes of interest. In the results list area 260, only those results corresponding to points within the boundary 300 are displayed. If these results turn out not to be of interest, the user may draw another boundary encompassing a different set of display points.

It is noted that the results area 260 displays list entries for those results for which display points are displayed within the boundary 300 and which satisfied the search criteria in the word search area 250. The box 300 may encompass other display positions corresponding to populated nodes in the node array, but if these did not satisfy the search criteria they will not be displayed and so will not form part of the subset of results shown in the list 260.

The present invention will now be described initially by way of example with reference to textual information items which are represented by visual information items, for example, video and still images.

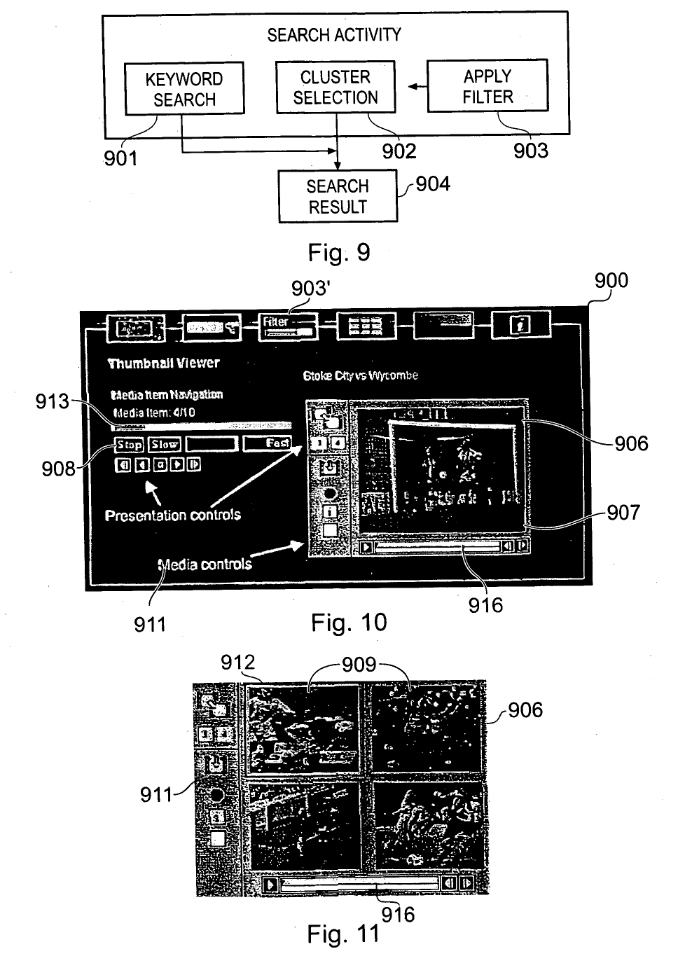

Referring to FIG. 9, a user may perform a search process by using a keyword search 901 as described above with respect to FIG. 7, and/or by selecting a cluster 902 by drawing a boundary 300 as described above with reference to FIG. 8. As indicated at 903, a filter may be applied to reduce the number of “hits”. The filter 903 may apply criterion such as genre, and date range, amongst other criteria, to the results of the search.

The result of the search is indicated at 904.

The results of the search may be displayed in accordance with the present invention as shown by way of example in FIG. 10, 11 or 12. Such display of the results may be in addition to the results list 260 shown in FIGS. 7 and 8 or instead of such a display.

Even with the use of a filter 903, the search may produce a very large number of “hits”. The user needs to be able to quickly determine what has been found. In the present example, the information items found by the search are represented by still images and/or video.

One embodiment of the present invention uses the technique of Rapid Serial Visual Presentation (RSVP) which is described in the paper “Patterns of Eye Gaze during Rapid Serial Visual Presentation, by Oscar de Bruijn & Robert Spence Imperial College of Science, Technology and Medicine, Exhibition Road, London SW7 2BT United Kingdom” and available from http://www.iis.ee.ic.ac.uk/˜odb/paper01 l.pdf. and which is incorporated herein by reference. As the name suggests, RSVP rapidly presents in succession many images. The paper presents several different ways of presenting images any of which may be used in the present invention. Examples of RSVP type include the following:—:

Keyhole RSVP in which only one image appears at one time, each image appearing at the same location at the same size.

Carousel RSVP in which each image describes an approximately circular trajectory from its emergence at a small size increasing to a maximum size then reducing again until it returns to its emergence location to be replaced by another image.

Collage RSVP in which a set of images is deposited in rapid sequence on a display area in such a way that many (e.g. 5 or 6) are visible at any one time.

Floating RSVP in which the initial view of an image is at the centre of a display area and small in size and which may be “out of focus”. The image moves e.g. diagonally across the display area increasing in size. Many images are shown simultaneously.

Shelf RSVP in which successive images follow a predetermined trajectory (as if moving along a shelf for example) starting small at an emergence point at an edge of the display area and increasing to a maximum at the centre of the display area and reducing again to disappear at another edge. Many images are displayed simultaneously moving along the trajectory.

The images which are displayed in the RSVP are derived from the list of the search results which are returned from the keyword search 901 and/or from results of an amended search produced by drawing a boundary 300 around a cluster 902. The search may be further defined using a filter 903.

Referring to FIG. 10, one example of RSVP applied to the present invention is shown. FIG. 10 shows a Graphical User Interface (GUI) 900 having a window 906 for displaying images 907, presentation controls 908, a filter control 903′ and media controls 911, 913 and 916 amongst other controls. The filter control 903′ selects filtering criteria as described above to reduce the number of “hits” provided by the search. The presentation controls 908 control one or more of the following: the RSVP type; selection of manual or automatic display of the succession of images; the rate of display if automatic display is selected; and the order of display of images; amongst other controls. The media controls 911 allow a user to select a media item, to view information about the selected item, and to control the presentation of the selected item as will be described in more detail below.

In FIG. 10, a succession of images are displayed one at a time in the window 906 corresponding to the keyhole RSVP described above

In FIG. 11, the window 906 simultaneously displays four streams of images. In FIG. 11, a stream of current interest may be selected using a presentation control 908

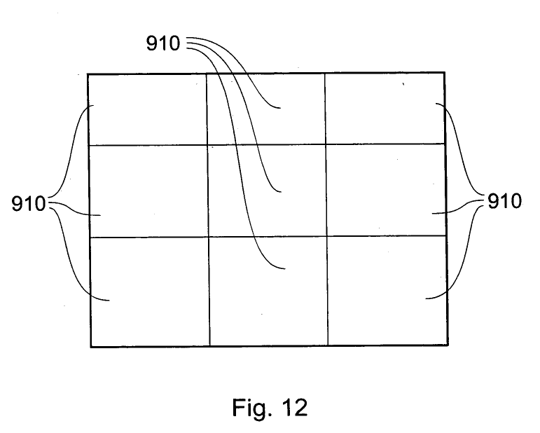

In FIG. 12, an array of images 910 is displayed in the window 906 simultaneously, corresponding to the collage RSVP described above.

Referring again by way of example to FIG. 11, the media controls 911 may be used to select one of the four streams, as indicated by the border 912. The selection of a representation in one stream also selects the information related to that selected representation.

The media controls 911 allow the user to select one of the succession of displayed images. If for example the selected image is a representative key stamp (RKS or thumbnail) representing a video sequence, the selection of the image allows the user to access a copy of the video and view it.

The presentation controls also include a scroll bar 913 which is a speed control for controlling the rate of presentation of images in the streams.

The presentation controls include a scroll bar 916 by which a user plays through the video of the selected image.

The streams of images in FIGS. 10 and 11 or the array of images of FIG. 12 may be accompanied by the display of the text titles of each image. Thus enables the use to spot any key words that may be of interest to them.

The sequence in which the images appear in an RSVP may be undefined. Alternatively the sequence may be defined according to a predetermined criterion set by the user: for example date order or order of relevance.

Whilst the invention has been illustrated with reference to images and video representing information items sought by a user, the invention is not limited to that. The search results 907, 909, 910 displayed may be textual items for example titles found by the search presented as a Rapid Serial Visual Presentation.

The displayed search results 907, 909, 910 may represent not the actual information items which the use seeks but links to those items. The links may be—universal resource identifiers for example. Selecting a displayed result would then initiate the link to the desired information item which the user seeks.

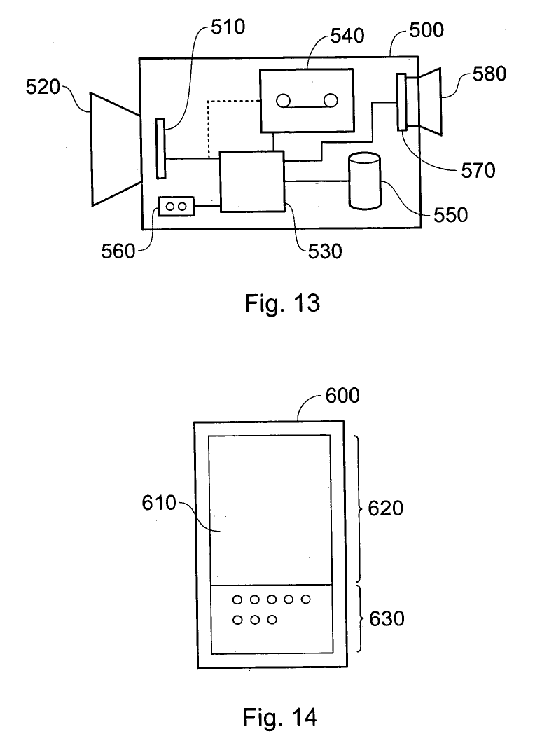

FIG. 13 schematically illustrates a camcorder 500 as an example of a video acquisition and/or processing apparatus, the camcorder including an image capture device 510 with an associated lens 520; a data/signal processor 530; tape storage 540; disk or other random access storage 550; user controls 560; and a display device 570 with eyepiece 580. Other features of conventional camcorders or other alternatives (such as different storage media or different display screen arrangements) will be apparent to the skilled man. In use, MetaData relating to captured video material may be stored on the storage 550, and an SOM relating to the stored data viewed on the display device 570 and controlled as described above using the user controls 560.

FIG. 14 schematically illustrates a personal digital assistant (PDA) 600, as an example of portable data processing apparatus, having a display screen 610 including a display area 620 and a touch sensitive area 630 providing user controls; along with data processing and storage (not shown). Again, the skilled man will be aware of alternatives in this field. The PDA may be used as described above in connection with the system of FIG. 1.

The paper “Interfaces for Palmtop Image Search” by Mark Derthick, Human Computer Interaction Institute, Carnegie Mellon University describes experiments in the use of RSVP on a palm top.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An information retrieval system in which a set of distinct information items map to respective nodes in an array of nodes by mutual similarity of the information items, so that similar information items map to nodes at similar positions in the array of nodes; the system comprising:
a user control for defining a search criterion for selecting information items;
a detector for detecting those positions within the array of nodes corresponding to the selected information items; and
a graphical user interface for displaying display points which are at positions within a display area on a user display;
the graphical user interface also displaying in a sequence in time a plurality of representations of the selected information items.

2. A system according to claim 1, wherein the graphical user interface is operable to display a two-dimensional display array of said display points.

3. A system according to claim 2, in which the mapping between information items and nodes in the array includes a dither component so that substantially identical information items tend to map to closely spaced but different positions in the array.

4. A system according to claim 1, in which the information items are mapped to nodes in the array on the basis of a feature vector derived from each information item.

5. A system according to claim 4, in which the feature vector for an information item represents a set of frequencies of occurrence, within that information item, of each of a group of information features.

6. A system according to claim 5, in which the information items comprise textual information, the feature vector for an information item represents a set of frequencies of occurrence, within that information item, of each of a group of words.

7. A system according to claim 1, in which the information items comprise textual information, the nodes being mapped by mutual similarity of at least a part of the textual information.

8. A system according to claim 6, in which the information items are pre-processed for mapping by excluding words occurring with more than a threshold frequency amongst the set of information items.

9. A system according to claim 6, in which the information items are pre-processed for mapping by excluding words occurring with less than a threshold frequency amongst the set of information items.

10. A system according to claim 1, wherein the said user control comprises:
search means for carrying out a search of the information items;
the search means and the graphical user interface being arranged to co-operate so that only those display points corresponding to information items selected by the search are displayed on the user display.

11. A system according to claim 1, wherein the said sequence in time is a serial visual presentation of the said representations.

12. A system according to claim 11, wherein the said representations are displayed one at a time in sequence in the same display zone.

13. A system according to claim 11, wherein a plurality of said representations are displayed at the same time in respective display zones.

14. A system according to claim 11, wherein a plurality of streams of representations are displayed at the same time in respective display zones.

15. A system according to claim 11, comprising a further user control for selecting a said representation, and causing the display of information related to the selected representation.

16. A system according to claim 1, wherein the said representation comprise images.

17. A system according to claim 1, where the said representations comprise text.

18. A system according to claim 1, wherein the said representation comprises links to the information items represented thereby.

19. A portable data processing device comprising a system according to claim 1.

20. Video acquisition and/or processing apparatus comprising a system according to claim 1.

21. An information retrieval method in which a set of distinct information items map to respective nodes in an array of nodes by mutual similarity of the information items, so that similar information items map to nodes at similar positions in the array of nodes; the method comprising the steps of:
defining a search criterion for selecting information items;
detecting those positions within the array of nodes corresponding to the selected information items; and
displaying display points which are at positions within a display area on a user display corresponding to the selected information items;
the graphical user interface also displaying in a sequence in time a plurality of representations of the selected information items.

22. A method according to claim 21, wherein the step of displaying displays a two-dimensional display array of said display points.

23. A method according to claim 21, wherein the said sequence in time is a serial visual presentation of the said representations.

24. A method according to claim 21, further comprising a further user control for selecting a said representation, and causing the display of information related to the selected representation.

25. Computer software having program code for carrying out a method according to claim 21.

26. A providing medium for providing program code according to claim 25.

27. A medium according to claim 26, the medium being a storage medium.

28. A medium according to claim 26, the medium being a transmission medium.

29. A user interface of an information retrieval system in which a set of distinct information items map to respective nodes in an array of nodes by mutual similarity of the information items, so that similar information items map to nodes at similar positions in the array of nodes; the interface comprising:
a user control for defining a search criterion for selecting information items; and
a graphical user interface having a display area arranged to display points which are at positions within a display area corresponding to the selected information items, and a display area arranged to display in a sequence in time a plurality of representations of the selected information items.

30. A user interface according to claim 29, wherein graphical user interface displays a two-dimensional display array of said display points.

31. A user interface according to claim 29, wherein the said sequence in time is a serial visual presentation of the said representations.

32. A user interface according to claim 29, further comprising a further user control for selecting a said representation, and causing the display of information related to the selected representation.

33. A user interface according to claim 29, further comprising a user control for applying further search criteria to the search.

34. A user interface according to claim 29, further comprising a presentation control for controlling the presentation of the said sequence of representations.
